(19) United States
(12) Patent Application Publication
(10) Pub. No.: US 2005/0104394 A1
(43) Pub. Date: May 19, 2005

(54) Pipe-handling tool

(76) Inventor: Rick D. Cortez, Austin, TX (US)

Correspondence Address: WAYNE J. COLTON, INC.;The Milam Building Suite 1032, 115 East Travis Street, San Antonio, TX, 78205, US

(21) Appl. No.: 10/899,382

(22) Filed: Jul. 26, 2004

(30) Foreign Application Priority Data
Jan. 24, 2003 (WO) PCT/US03/02368

(51) Int. Cl. B65G 7/12

(52) U.S. Cl. 294/15; 294/103.1

(57) ABSTRACT

A safety tool takes the form of a base plate having a plurality of mounting apertures for selectively mounting one or more pipe engaging members. The mounting apertures are arranged in a symmetrical grid such that the pipe engaging members may be selectively mounted upon the base plate in any of a plurality of orientations. One or more hoisting apertures may be provided on the base plate for utilization of a mechanical hoist in the lifting operation. A handle, which may be removable, may be provided on the base plate for manual manipulation of the tool. The symmetrical grid enables utilization of the tool with one, two or several pipe engaging members or with the pipe engaging member or members in various orientations with respect to the base plate.

### RELATED APPLICATIONS

This application claims priority, under 35 U.S.C. § 120, to P.C.T. international patent application Serial No. PCT/US03/02368 filed Jan. 24, 2003 and designating the United States of America, which claims all available benefit, under 35 U.S.C. § 119(e), of U.S. provisional patent application Ser. No. 60/351,750 filed Jan. 25, 2005. By this reference, the full disclosures, including the claims and drawings, of P.C.T. international patent application Serial No. PCT/US03/02368 and U.S. provisional patent application Ser. No. 60/351,750 are incorporated herein as though now set forth in their respective entireties.

### FIELD OF THE INVENTION

The present invention relates to pipe-handling tools. More specifically, the present invention relates to a multiple-configuration tool for handling a variety of sizes, shapes and weights of pipe, as particularly useful in the oilfield and similar industries.

### BACKGROUND OF THE INVENTION

In oilfield operations, it is frequently necessary to manually lift and carry oilfield pipe or “frac” pipe. Similarly, in fire fighting operations, fire hoses must be lifted and carried by hand. Typically, such pipes and hoses must be handled under wet and slippery conditions, which are generally hazardous to the personnel involved. Additionally, such pipes and hoses are generally quite heavy and difficult to handle, even under dry conditions, causing extreme physical fatigue in of personnel involved.

Although devices have been proposed for more safely handling pipes and hoses, such devices generally suffer impracticalities that militate away from their widespread use. In particular, the previously proposed devices are limited to very specific applications, resulting in a necessity to purchase a separate device for each particular use. For example, large and small pipes generally cannot both be handled by a single device. Likewise devices with the structural integrity necessary for handling heavy pipes are generally too heavy for safe manual use. Finally, the previous devices are limited in the manner in which they may be used in cooperation with mechanical hoists.

It is therefore an overriding object of the present invention to provide a single pipe-handling tool that may be readily and economically configured to meet the particular needs of the widest variety of pipe-handling applications.

### SUMMARY OF THE INVENTION

In accordance with the foregoing objects, the present invention—a pipe-handling tool—generally comprises a tool comprising a base plate having a plurality of mounting apertures for selectively mounting one or more pipe engaging members; at least one pipe engaging member; and wherein said mounting apertures are arranged in a symmetrical grid such that said pipe engaging member may be selectively mounted upon said base plate in any of a plurality of orientations. One or more hoisting apertures may be provided on the base plate for utilization of a mechanical hoist in the lifting operation. Additionally, or in the alternative, a handle, which may be removable, may be provided on the base plate for manual manipulation of the tool. The symmetrical grid enables utilization of the tool with one, two or several pipe engaging members or with the pipe engaging member or members in various orientations with respect to the base plate, thereby enabling the tool to be readily adapted for a wide variety of pipe handling operations.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a perspective view, the preferred embodiment of the pipe-handling tool of the present invention;

FIG. 2 shows, in a perspective view, a second configuration of the pipe-handling tool of FIG. 1;

FIG. 3 shows, in an exploded perspective view, the pipe-handling tool of FIG. 1;

FIG. 4 shows, in a rear elevational view, the pipe-handling tool of FIG. 1;

FIG. 5 shows, in a partially cutaway side elevational view, the pipe-handling tool of FIG. 1;

FIG. 6 shows, in a perspective view, the pipe-handling tool of FIG. 1 as employed in a first application;

FIG. 7 shows, in a perspective view, the pipe-handling tool of FIG. 1 as employed in a second application; and

FIG. 8 shows, in a perspective view, the pipe-handling tool of FIG. 1 as employed with the assistance of a mechanical hoist in the application of FIG. 7.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

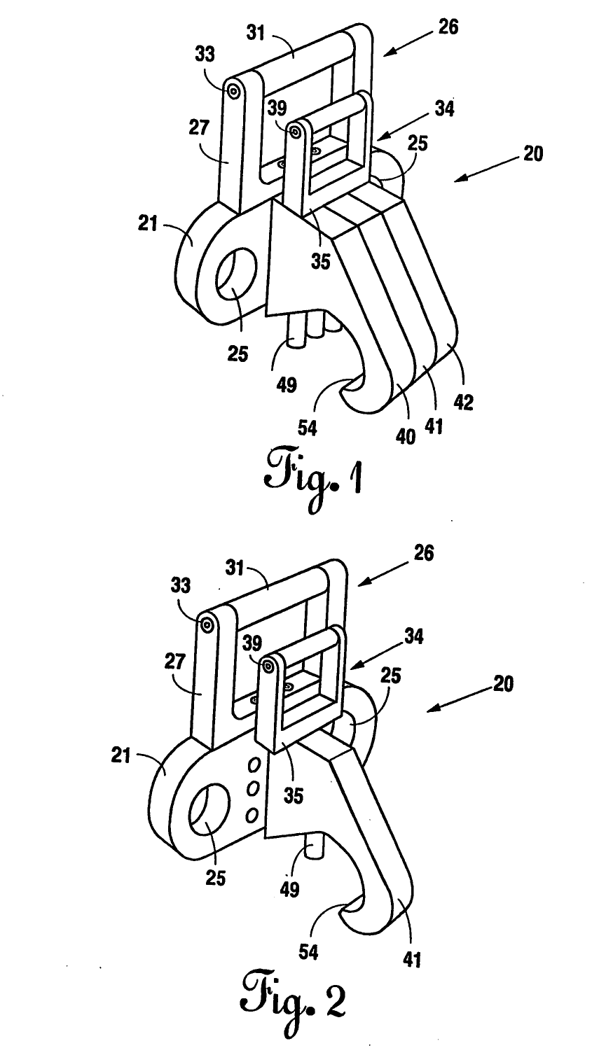

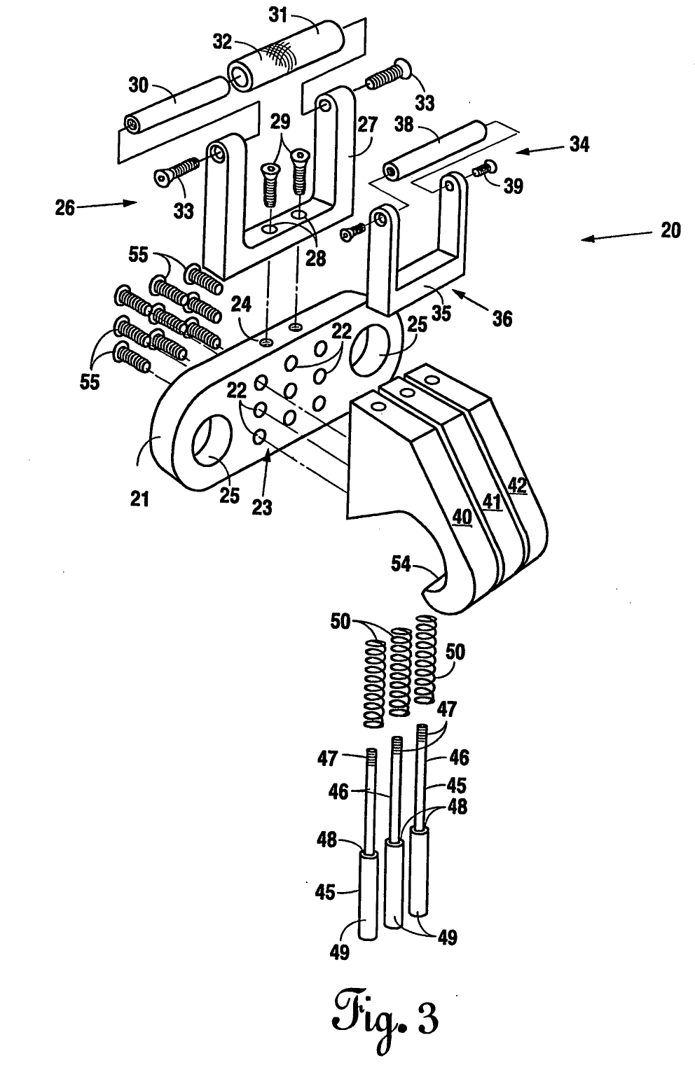

Referring now to the figures, the pipe-handling tool 20 of the present invention is shown to generally comprise a base plate 21 upon which is mounted one or more clamping units 40, 41, 42 for engaging a pipe or hose. As particularly shown in FIGS. 1 and 2, and as will be better understood further herein, the pipe-handling tool 20 of the present invention is specifically adapted to be readily reconfigured to meet the needs of a wide variety of pipe-handling applications. For example, as shown in FIG. 1, a first clamping unit 40, a second clamping unit 41 and a third clamping unit 42 may be simultaneously secured to the base plate 21 for heavy duty applications such as the towing of a heavy pipe under electrical wires or the insertion of a long and heavy pipe into a rat hole. On the other hand, the first clamping unit 40 and the third clamping unit 42 may be removed, as shown in FIG. 2, thereby leaving only the second clamping unit 42 in place for light duty applications such as the manual repositioning of a short pipe. In this manner, the pipe-handling tool 20 of the present invention may be selectively strengthened as required for heavy, mechanical hoist assisted operations yet may be made as light as possible for those operations in which the pipe will be handled manually. Additionally, as also will be better understood further herein, the pipe-handling tool 20 is specifically adapted for configuration in a manner extremely conducive to the handling of curved pipes. In particular, as shown in FIG. 6, the pipe-handling tool 20 may be configured with only the second clamping unit 41 affixed to the base plate 21 in an orientation perpendicular to the orientation of the clamping units 40, 41, 42 as depicted in FIGS. 1 and 2. In this configuration, a hoisting hook 51 may be utilized with the tool 20 to handle a large and heavy curved pipe.

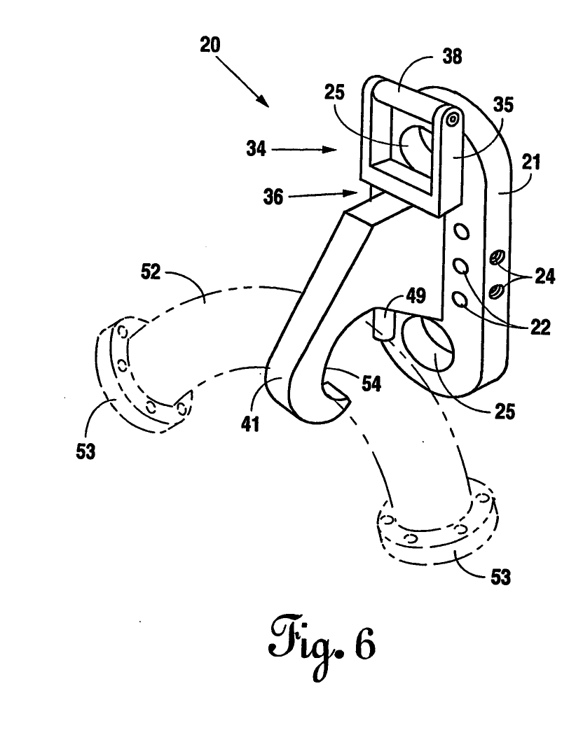

Referring now to FIGS. 3 through 5, the construction of the pipe-handling tool 20 is detailed. While various assemblies and sub-assemblies are described, it should be noted throughout that the pipe-handling tool 20 of the present invention is specifically designed to enable a user to select from a multitude of possible configurations according to the user's particular immediate need. With this in mind, it is noted that at least some of the assemblies and/or sub-assemblies will only be utilized in certain applications or will be utilized in varying manners depending upon the application. In any case, as best shown in FIG. 3, the pipe-handling tool 20 of the present invention may be considered an assembly comprising a base plate 21 having attached thereto one or more clamping units 40, 41, 42. A carrying handle 26 may be dependently attached to the base plate 21 for manually carrying a gripped pipe or for facilitating placement of a gripped pipe even though the pipe-handling tool 20 may be utilized in conjunction with a mechanical hoist. Additionally, a release handle 34 serves to secure a piston 45 within a piston bore 43 of each clamping unit 40, 41, 42 as well as to operate the pistons 45 for the release of a gripped pipe.

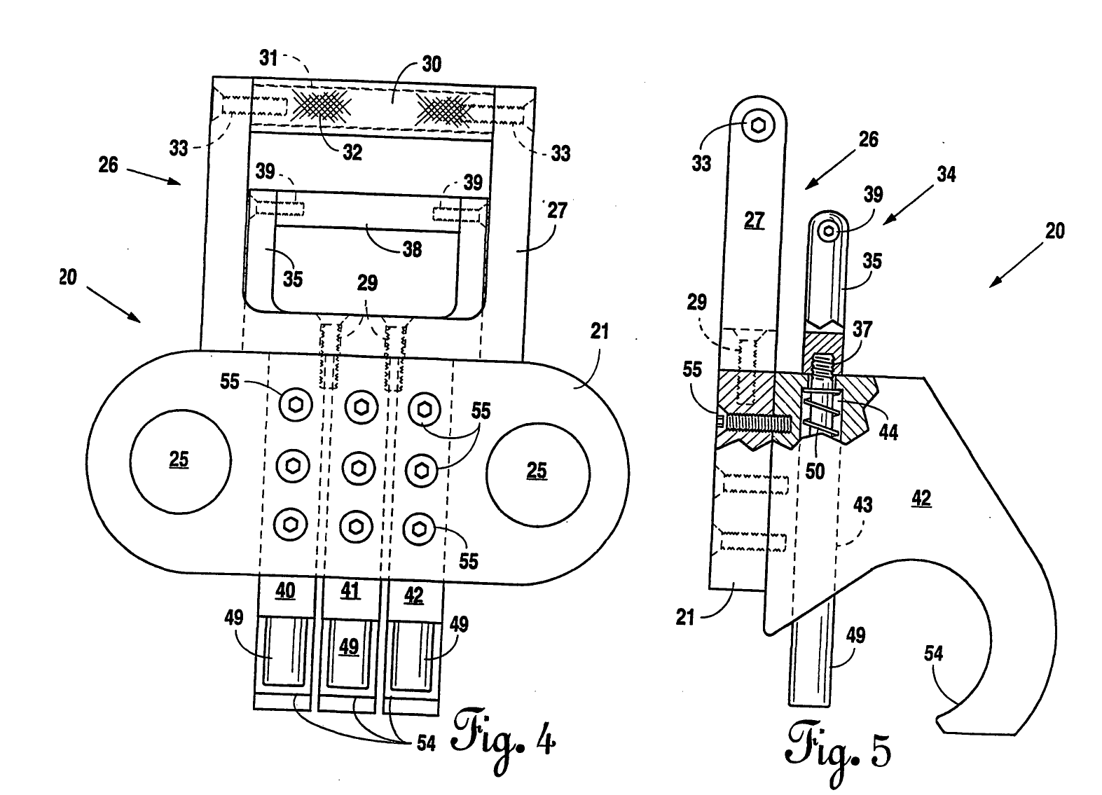

As shown in FIGS. 3 through 5, the base plate 21 preferably comprises a high-strength alloy material milled or laser cut for dependently supporting the clamping units 40, 41, 42 and the carrying handle 26. Additionally, one or more hoisting 25 apertures are preferably provided at strategic locations on the base plate 21 for receiving a hoisting hook 51 as may be required in certain applications. As best shown in FIGS. 3 and 4, a plurality of clamping unit mounting apertures 22 through the base plate 21 are provided for receiving therethrough Allen head screws 55 utilized to dependently secure thereto one or more of the clamping units 40, 41, 42. As shown in the figures, the clamping unit mounting apertures 22 are preferably placed on a symmetrical grid 23 such that the clamping units 40, 41, 42 may be oriented vertically as shown in FIGS. 1 and 2 or may be oriented horizontally as shown in FIG. 6. Finally, the base plate 21 is provided with a plurality of threaded holes 24 for receiving Allen head screws 29 utilized to secure the carrying handle 26 to the base plate 21.

As also shown in FIGS. 3 through 5, the carrying handle 26 preferably comprises a C-shaped base 27 having a plurality of mounting apertures 28 through the lower portion thereof for affixing the carrying handle 26 to the base plate 21 with a plurality of Allen head mounting screws 29. Two Allen head screws 33 are utilized to secure an aluminum rod 30 between the distal ends of the base 27. An aluminum sleeve 31, which may be provided with diamond cuts 32 for better gripping, is rotatably supported upon the rod 30. In this manner, a user may have a sure grasp upon the carrying handle 26 notwithstanding that the pipe-handling tool 20 may swing freely with respect to the sleeve 31, thereby minimizing strain upon the user's wrist as may otherwise occur were the handle to be fixed.

Like the carrying handle 26, the release handle 34 also comprises a C-shaped base 35. The underside 36 of the release handle 34, however, comprises a plurality of threaded holes 37 for receiving one or more of the pistons 45 of the clamping units 40, 41, 42, as will be better understood herein. Although those of ordinary skill in the art will recognize that the finger grip 38 of the release handle 34 may rotate upon a rod such as the rod 30 provided for the carrying handle 26, Applicant has found it suitable to simply provide a finger grip 38 secured with a plurality Allen head screws 39 between the distal portion of the arms of the base 35.

As particularly shown in FIGS. 3 through 5, each clamping unit 40, 41, 42 is provided with a tubular piston bore 43 in which may be inserted a piston 45. Each piston 45 comprises a neck 46, having a male threaded end 47, and a plunger 49. As each piston 45 is inserted into a respective clamping unit 40, 41, 42, a piston spring 50 is compressed between a shoulder 48 on the plunger 49 and a shoulder 44 on the upper portion of the tubular piston bore 43. The inserted piston 45 is then screwed into one of the threaded holes 37 on the underside 36 of the base of the release handle 34. In this manner, the release handle 34 cooperates with the clamping units 40, 41, 42 to secure the pistons 45 in position in the respective clamping units 40, 41, 42. In operation, pulling the release handle 34 away from the installed clamping units 40, 41, 42 causes retraction of the plungers 49 into the clamping units 40, 41, 42 for gripping or release of a pipe 52. When the release handle 34 is in its normal position, biased against the clamping units 40, 41, 42 by the piston springs 50, the plungers 49 securely hold a pipe 52 within the scoop 54 of each clamping unit 40, 41, 42.

Referring now to FIGS. 1, 2 and 6 through 8, the preferred operation of the present invention is detailed. In particular, as shown in FIGS. 2 and 6, various applications may dictate the use of only a single clamping unit, such as the second clamping unit 41 shown in each figure. For example, the configuration of FIG. 2 is particularly useful for the manual handling of a short length of relatively lightweight pipe. In this case, the user simply grasps the pipe-handling tool 20 by the carrying handle 26 and presses the pipe-handling tool 20 downward onto a pipe 52 in a position like that shown in FIG. 7. The downward force of the pipe-handling tool 20 will cause the piston 45 to retract against the piston spring 50 into the piston bore 43 allowing the pipe 52 to come to rest within the scoop 54 of the clamping unit 41. Once inserted, the pipe 52 will slide out of the way of the piston 45, thereby allowing the piston 45 to again extend from the piston bore 43. The plunger 49 portion of the piston 45 will then hold the pipe 52 securely between the plunger and the scoop 54 of the clamping unit 41. At this point, the pipe 52 may be securely handled with the user safely grasping the pipe-handling tool 20 by the carrying handle 26. After the user has performed his or her task with respect to the pipe 52, the release handle 34 is simply pulled to cause the plunger 49 to retract into the piston bore 43, thereby allowing the pipe 52 to be released from the pipe-handling tool 20.

A similar application is depicted in FIG. 6. In this case, however, it is noted that the pipe 52 has a curved shaped. While the configuration of FIG. 2 would be suitable for grasping such a pipe 52, the configuration of FIG. 6 is preferred in cases where the pipe 52 is extremely heavy and must be handled with the assistance of a hoisting hook 51. In this instance, the clamping unit 41 is preferably aligned with the hoisting apertures 25 such that a single clamping unit 41 may be utilized, as is often necessary with a curved pipe 52, without excessive lateral forces being applied to the plunger 49.

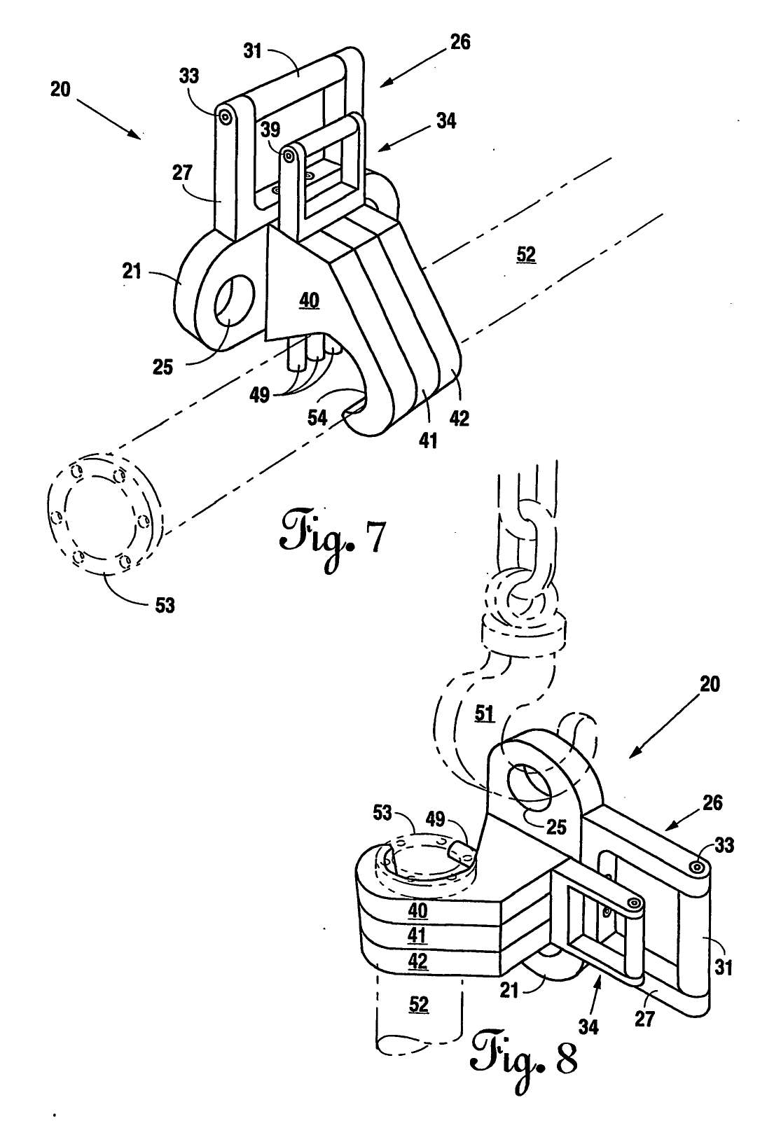

As shown in FIGS. 7 and 8, a large and heavy pipe 52 may be handled utilizing the pipe-handling tool 20 configured with three clamping units 40, 41, 42. In this case, the pipe-handling tool 20 is applied to the pipe as previously described and, thereafter, a hoisting hook 51 is inserted through one of the hoisting apertures 25. Applicant has found that the additional strength provided by the multiple clamping units 40, 41, 42 allows for even a very large and heavy pipe to be handled in the completely vertical orientation shown in FIG. 8, where the pipe 52 has slid through the clamping units 40, 41, 42 such that the flange 53 of the pipe 52 rests adjacent the first clamping unit 40.

Although not shown in the figures, those of ordinary skill in the art will recognize that other configurations of the pipe-handling tool 20 of the present invention may also be desirable. For example, it may be desirable to use only the first clamping unit 40 and the third clamping unit 42 in an application where a curved pipe 52, such as shown in FIG. 6, has a flange 53 at the desired lifting point. In this case, the flange 53 may be positioned in the open space provided by removal of the second clamping unit 41. Additionally, those of ordinary skill in the art will recognize that certain applications will require only the additional strength of two clamping units. For example, towing of a pipe 52 beneath low electrical wires is one such application. In this case, the user has the option of adding only a second clamping unit should the pipe-handling tool 20 have been previously configured with only a single clamping unit. In this manner, time may be saved through the flexibility of the pipe-handling tool 20 of the present invention.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. In any case, because the scope of the present invention is much broader than any particular embodiment, the foregoing detailed description should not be construed as a limitation of the scope of the present invention, which is limited only by the claims appended hereto.

1. A tool for handling heavy pipe, said tool comprising:
a base plate having a plurality of mounting apertures for selectively mounting one or more pipe engaging members;
at least one pipe engaging member; and
wherein said mounting apertures are arranged in a symmetrical grid such that said pipe engaging member may be selectively mounted upon said base plate in any of a plurality of orientations.

2. The tool as recited in claim 1, wherein said base plate comprises at least one hoisting aperture for utilization of a mechanical hoist to handle the pipe.

3. The tool as recited in claim 2, said tool further comprising a handle affixed to said base plate for manual manipulation of said tool.

4. The tool as recited in claim 1, said tool further comprising a handle affixed to said base plate for manual manipulation of said tool.

5. The tool as recited in claim 4, wherein said handle is readily removable from said base plate.

6. The tool as recited in claims 1, said tool comprising a plurality of pipe engaging members.

7. The tool as recited in claim 1, wherein said pipe engaging member comprises:
a fixed scoop for abutting engagement with the pipe; and
a retractable piston, said retractable piston being adapted to secure the pipe against said scoop.

8. The tool as recited in claim 7, said tool further comprising a release handle, said release handle being adapted to operably retract each said piston to within its respective pipe engaging member.

9. The tool as recited in claim 8, wherein each said retractable piston is spring-biased without its respective pipe engaging member.

10. The tool as recited in claim 7, wherein each said retractable piston is spring-biased without its respective pipe engaging member.

11. The tool as recited in claim 1, wherein said symmetrical grid comprises a three by three array of apertures.
